(19) United States
(12) Patent Application Publication
(10) Pub. No.: US 2022/0286807 A1
(43) Pub. Date: Sep. 8, 2022

(54) NETWORK RTK SERVICE METHOD, NETWORK RTK SERVER, COMMUNICATION BASE STATION, AND STORAGE MEDIUM

(71) Applicant: TruePoint Technology, Inc., Beijing (CN)

(72) Inventors: Kongzhe CHEN, Beijing (CN); Guangyu ZHOU, Beijing (CN); Lei HUANG, Beijing (CN)

(21) Appl. No.: 17/573,325

(22) Filed: Jan. 11, 2022

Related U.S. Application Data
(60) Provisional application No. 63/157,275, filed on Mar. 5, 2021.

(51) Int. Cl. H04W 4/02; H04W 64/00; H04W 48/16

(52) U.S. Cl. CPC H04W 4/023; H04W 64/003; H04W 4/027; H04W 48/16

(57) ABSTRACT

A network Real-Time Kinematic (RTK) service method includes acquiring, by a network RTK server, position information of one or more communication base stations. The method includes allocating, by the network RTK server, a corresponding RTK base station correction number to the communication base station according to the position information. The RTK base station correction number is a differential correction number of an RTK physical base station within a first preset distance range from the communication base station or a differential correction number of an RTK virtual base station generated according to the position information. The method includes sending, by the network RTK server, the allocated RTK base station correction number to the communication base station.

### TECHNICAL FIELD

Embodiments of the present invention relate to, but not limited to, the technical field of satellite navigation and positioning, and in particular, to a network RTK service method, a network RTK server, a communication base station, and a storage medium.

### BACKGROUND

A Global Navigation Satellite System (GNSS) is a man-made satellite system having a plurality of satellites, and can send signal including position and time information to ground GNSS receiving machines. By means of the signals, the receiving machines can implement positioning. Currently, the main GNSS systems include a Galileo navigation satellite system, a US Global Positioning System (GPS), a Russian GLONASS navigation satellite system, and a Chinese Beidou navigation satellite system. As the development of global satellite positioning technique, centimeter or even millimeter level positioning precision demands are more and more urgent, demand ranges are more and more extensive, such as surveying and mapping, fine agriculture, intelligent robots, unmanned aerial vehicles, UAV and other fields require high precision position information.

In the prior art, a single satellite-positioning receiver without precision data support cannot complete centimeter-to-decimeter level positioning. Technology that provides centimeter to decimeter level satellite positioning services mainly includes Real-Time Kinematic (RTK) technology and Precise Point Positioning (PPP) technology, where the RTK technology is the most widely used high precision satellite positioning technology.

The RTK techniques can be divided into single-station RTK techniques and network RTK techniques. The single-station RTK techniques relate to constructing a receiving machine on a known spot as a reference station to provide difference data for a receiving machine needing positioning (a mobile station). The network RTK techniques relate to establishing a plurality of reference stations, and by using data of the plurality of reference stations, a server being capable of calculating difference data based on a user position (the mobile station). By using the difference data, the mobile station can completely eliminate a satellite clock error, and can also eliminate most of satellite orbit and atmospheric propagation errors; positioning precision can reach 1 cm.

The RTK needs to be supported by the base station. For the single-station RTK, an available range of the difference data is relatively limited, a function range of the RTK base station generally cannot exceed 50 km. To reduce base station density, the network RTK techniques are greatly developed, such as Virtual Reference Stations (VRS), Flächen Korrektur Parameter (FKP), Master Auxiliary Concept (Mac), and other techniques, where VRS is the most widely used network RTK technique.

Regarding future intelligent driving, high-precision logistics and other large range of high-precision RTK applications, a range of coverage is wide, and the number of users is large. The server needs to provide RTK correction numbers to tens of millions of users nationwide at the same time. In the current network RTK mode, the server needs to know the position of each user, so as to provide the differential correction number of the RTK virtual base station based on the mobile station position or the differential correction number of the RTK physical base station closest to the mobile station. This requires the support of two-way communication, and the requirements for the server are extremely high. For the VRS mode, the server needs to process the requests of tens of millions of users at the same time, and generate for each user the differential correction number of the RTK virtual base station based on the user's real-time position, which is a huge amount of calculation. The current mode can meet the tens of millions of user requests but cannot meets future requests from tens of millions of users. Even if using a single station mode, the server also needs to allocate the nearest physical base station data for each user; retrieving the nearest base station for tens of millions of users from thousands of base stations also has a huge amount of calculation and cannot be completed by the current mode.

### SUMMARY

Embodiments of the present invention provide a network RTK service method, a network RTK server, a communication base station, and a storage medium, which can reduce the amount of calculation of the network RTK server and do not need bi-directional communication between the network RTK server and the network RTK user.

An embodiment of the present invention provides a network Real-Time Kinematic (RTK) service method, including:

acquiring, by a network RTK server, position information of one or more communication base stations;

allocating, by the network RTK server, a corresponding RTK base station correction number to the communication base station according to the position information, the RTK base station correction number being a differential correction number of an RTK physical base station within a first preset distance range from the communication base station or a differential correction number of an RTK virtual base station generated according to the position information; and

sending, by the network RTK server, the allocated RTK base station correction number to the communication base station.

In an exemplary embodiment, allocating, by the network RTK server, a corresponding RTK base station correction number to the communication base station according to the position information includes:

performing, by the network RTK server, following operations on each communication base station:

detecting whether the first preset distance range of the communication base station includes an RTK physical base station;

if the RTK physical base station is within the first preset distance range of the communication base station, allocating a differential correction number of the RTK physical base station to the communication base station; and

if the RTK physical base station is not within the first preset distance range of the communication base station, generating a differential correction number of the RTK virtual base station according to the position information and allocating to the communication base station.

In an exemplary embodiment, generating a differential correction number of the RTK virtual base station according to the position information includes:

searching a station region to which the communication base station belongs according to the position information; and

calculating a differential correction number of the RTK virtual base station at a preset position in the station region.

An embodiment of the present invention further provides a storage medium storing one or more programs, where the one or more programs can be executed by one or more processors, to implement steps of the network RTK service method according to any one above.

An embodiment of the present invention further provides a network RTK server, including a processor and a memory, where the processor is configured to execute network RTK service programs stored in the memory, to implement steps of the network RTK service method according to any one above.

An embodiment of the present invention further provides a network RTK service method, including:

receiving, by a communication base station, an RTK base station correction number sent by a network RTK server, the RTK base station correction number being a differential correction number of an RTK physical base station within a first preset distance range from the communication base station or a differential correction number of an RTK virtual base station generated according to the position information; and

sending, by the communication base station, the received RTK base station correction number to one or more network RTK users connected to the communication base station.

In an exemplary embodiment, sending, by the communication base station, the received RTK base station correction number to one or more network RTK users connected to the communication base station includes:

storing, by the communication base station, registration information of the one or more network RTK users connected to the communication base station;

sending, by the communication base station through broadcasting, the received RTK base station correction number to the one or more network RTK users connected to the communication base station.

An embodiment of the present invention further provides a storage medium storing one or more programs, where the one or more programs can be executed by one or more processors, to implement steps of the network RTK service method according to any one above.

An embodiment of the present invention further provides a communication base station, including a processor and a memory, where the processor is configured to execute network RTK service programs stored in the memory, to implement steps of the network RTK service method according to any one above.

An embodiment of the present invention further provides a network RTK server, including a position acquisition module, an RTK allocation module, and a communication module, where:

the position acquisition module is configured to acquire position information of one or more communication base stations and notify the RTK allocation module;

the RTK allocation module is configured to receive a notification from the position acquisition module, allocate a corresponding RTK base station correction number to the communication base station according to the position information, the RTK base station correction number being a differential correction number of an RTK physical base station within a first preset distance range from the communication base station or a differential correction number of an RTK virtual base station generated according to the position information, and notify the communication module; and

the communication module is configured to receive a notification from the RTK allocation module and send the allocated RTK base station correction number to the communication base station.

An embodiment of the present invention further provides a communication base station including an RTK receiving module and an RTK sending module, where:

the RTK receiving module is configured to receive an RTK base station correction number sent by a network RTK server, the RTK base station correction number being a differential correction number of an RTK physical base station within a first preset distance range from the communication base station or a differential correction number of an RTK virtual base station generated according to the position information and notify the RTK sending module; and

the RTK sending module is configured to receive a notification from the RTK receiving module and send the received RTK base station correction number to one or more network RTK users connected to the communication base station.

In the network RTK service method, network RTK server, communication base station, and storage medium provided by the embodiments of the present invention, the corresponding RTK base station correction number is allocated to the communication base station according to the position information of the communication base station, and the received RTK base station correction number is sent by the communication base station to a network RTK user, there is no need for bi-directional communication between the network RTK server and network RTK users, thereby reducing the amount of calculation, complexity, and a data transmission of the network RTK server and meeting a large amount of needs for wide area network RTK services by intelligent driving, intelligent robots, and UAVs in future.

Other features and advantages of the embodiments of the present invention would be elaborated in the following description, moreover, would become obvious from the description in part, or would be understood by implementing the embodiments of the present invention. Other advantages of the embodiments of the present invention may be implemented and acquired from solutions described in the description, claims, and accompany drawings.

### BRIEF DESCRIPTION OF THE DRAWINGS

The accompanying drawings are provided for understanding of the technical solutions of the embodiments of the present invention and constitute a part of the description, and explain the technical solutions of the present invention together with the embodiments of the present invention, but do not constitute a limitation to the technical solutions of the embodiments of the present invention.

FIG. 1 is a flow chart I of an exemplary network RTK service method of an embodiment of the present invention;

FIG. 2 is a flow chart II of an exemplary network RTK service method of an embodiment of the present invention;

FIG. 3 is a schematic structural diagram of an exemplary network RTK server of an embodiment of the present invention; and

FIG. 4 is a schematic structural diagram of an exemplary communication base station of an embodiment of the present invention.

### DETAILED DESCRIPTION

The present invention describes multiple embodiments, but the description is exemplary rather than restrictive; moreover, it is obvious to persons having ordinary skill in the art that there may be more embodiments and implementation solutions within the scope covered by the embodiments described in the present invention. Although many possible feature combinations are shown in the accompanying drawings and discussed in specific implementations, many other combinations of the disclosed features are also possible. Except where expressly restricted, any feature or element of any embodiment may be used in combination with or in place of any other feature or element of any other embodiment.

Embodiments of the present invention include and conceive combinations of features and elements known to persons having ordinary skill in the art. Disclosed embodiments, features, and elements of the present invention may also be combined with any conventional feature or element to form a unique solution of invention defined by the claims. Any feature or element of any embodiment may also be combined with features or elements from other solutions of invention to form another unique solution of invention defined by the claims. Hence, it should be understood that any feature shown and/or discussed in the embodiments of the present invention may be implement separately or in any proper combination. Hence, in addition to the limitation made according to the accompanying claims and equivalent replacements thereof, the embodiments are not subjected to other limitations. In addition, various amendments and changes may be made in the scope of protection of the accompany claims.

In addition, when describing representative embodiments, the specification may present the method and/or process as a specific step sequence. However, the method or process does not depend on the degree of the specific order of the steps of the text. The method or process should not be limited to the steps of the specific order. As to be understood by persons having ordinary skill in the art, other step orders are also possible. Hence, the specific order of the steps stated in the specification should not be explained as the limitation to the claims. In addition, the claims for the method and/or process should not be limited to execution of the steps thereof according to the written order. A person skilled in the art could easily understand that these orders can be changed and are still held in the spirits and ranges of the embodiments of the present invention.

RTK can rapidly implement centimeter level high precision positioning and is the most widely used high precision satellite positioning technology, but RTK needs the support from the base station correction number. Using the correlation of errors affecting positioning precision such as satellite orbit errors, satellite clock errors, ionosphere errors, and troposphere errors between the base station and the user mobile station, the base station correction number can completely eliminate the mobile station satellite clock error and can also weaken most of the satellite orbit errors, ionosphere error and troposphere errors. However, the correlation of the satellite orbit errors, ionosphere error and troposphere errors is weakened as the increasing of the distance between the base station and the mobile station. In an area with relatively active ionosphere, a single base station can only provide the RTK correction number for the users in a radius range of 20 km. Providing the correction numbers for the RTK users in a large range by means of a single station needs to build a large amount of RTK base stations.

By means of establishing a Continuously Operating Reference Stations (CORS) network, the errors of the ionosphere, troposphere, and satellite orbit in the coverage range are modeled, so as to greatly reduce the base station density and reduce the number of the base stations. The distance between the base stations may be expanded to a hundred km or more. The existing CORS network is generally regional, and many cities establish their own CORS networks. The CORS network of the region makes great contributions to applications of small static or dynamic ranges such as surveying and mapping, deformation monitoring, and fine agriculture. With the emergence of a wide range of dynamic high precision applications in the intelligent era, particularly the cross-city and even cross-provincial applications such as intelligent driving and high-precision logistics, a larger range of CORS network support is needed, and CORS network has also entered the era of one national network. For this kind of large-scale CORS network with one national network, there are shortcomings in all of VRS, FKP and Mac.

VRS needs bi-directional communication. VRS needs to know a real-time position of the user to facilitate the generation of the differential correction number of the user position based RTK virtual base station. In addition, the VRS server cannot meet real-time calculation needs of a large amount of users. VRS needs to generate the differential correction number of the user position based RTK virtual base station for each user. However, the correction number is obtained through specific algorithm calculation. For the current local area VRS or a wide area VRS with a small amount of users, the server can meet real-time requests of tens of thousands of users. However, for the future one national network, even the cloud server will face great pressure in the face of real-time requests from tens of millions of intelligent driving users, intelligent robots, and UAVs in the intelligent era.

FKP cannot generate a wide area range of error models. FKP neither needs bi-directional communication, nor needs to generate a specific correction number for each user. FKP, i.e., regional correction number model or local area correction number model, is only applicable to provide error models of ionosphere, troposphere, and satellite orbit for users within a local area range. FKP can only fit linear changes of ionosphere, troposphere, satellite orbit and other errors in east-west and north-south directions through parameters. For a small range, the variation of these errors is nearly linear changes and the fitting error is small. For a large CORS network like one national network, ionosphere, troposphere and satellite orbit errors cannot change linearly in the national range, so they cannot be fitted by two parameters of east-west direction and north-south direction. Therefore, the FKP method cannot meet the requirements of such a large CORS network with one national network facing intelligent driving in the future.

The amount of data transferred in Mac master-slave mode is too large. In the master-slave mode, observation values of the master station and correction number information of all slave stations with respect to the master station are required to be released. For thousands of tracking stations in one national network, the data amount is too large to be transmitted in real time. Moreover, due to the long distance, the satellites tracked by the slave station and the master station are different, and the correction number of the slave station with respect to the master station only includes the satellites that the slave station and the master station see in common, so that the correction number of the satellite number available to the user will be greatly reduced, and even if the user receives them, the RTK performance will be affected.

Via the application inventor's study, it is found that the current VRS network RTK users basically use a 4G wireless communication mode to interact with the network RTK server and upload their own real-time position to the network RTK server; the network RTK server calculates, according to user's position, the differential correction number of the RTK virtual base station based on this position and returns to the users. In the interaction process between the user and the server, the purpose of bi-directional communication is to inform the server of the user's position. Since the user communicates through the 4G wireless network, the user is necessarily connected to a communication base station with strongest signals (usually the nearest), and the position of the communication base station is generally known, even though some communication base stations are temporary or even mobile, the communication base station positions can also be calculated through various channels, for example, through the installation of satellite positioning device or through the surrounding position known communication base station, the position is determined according to the signal strength. Hence, the network RTK server can generate the differential correction number of the RTK virtual base station based on the position of each base station, which is broadcast to the mobile communication terminal, i.e., the network RTK user, connected to the communication base station by the communication base stations. Since the communication base station service range is limited, the urban area is generally within 1 km, and no more than 5 km in remote areas, while the effective range of the RTK virtual base station differential correction number (more than 20 km) is far more than the coverage range of the communication base station, i.e., 5 km, based on the communication base station position, the differential correction number of the RTK virtual base station is valid for users who can be connected to the communication base station. In this way, network RTK users do not need to report their positions to the server, and bi-directional communication is not required. The server also does not need to generate a virtual base station correction number for each network RTK user, greatly reducing the amount of calculation of the server.

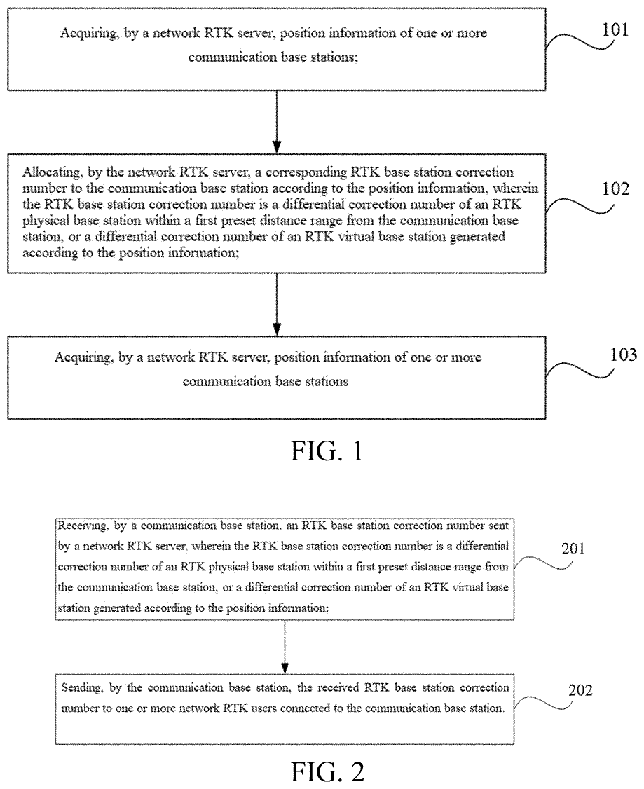

As shown in FIG. 1, a network RTK service method according to an embodiment of the present invention includes:

Step 101: a network RTK server acquires position information of one or more communication base stations.

In an exemplary embodiment, the network RTK server pre-stores position information of one or more communication base stations or receives at fixed periods the position information of one or more communication base stations.

Specifically, for the fixed communication base station, the network RTK server can allocate the position information based RTK base station correction number for each communication base station as long as storing the position information (e.g., coordinates) of each communication base station. For the temporary communication base station or mobile communication base station set up to relieve the communication pressure, such a base station only needs to report its real-time position to the network RTK server periodically, and the network RTK server can allocate the RTK base station correction number based on its position information. The position of the temporary communication base station or mobile communication base station may be determined by installing a satellite-positioning device or by a communication base station with a known surrounding position (for example, according to the signal strength of the received wireless signal of the surrounding communication base station).

In an exemplary embodiment, the communication base station may be a short range wireless communication base station, for example, a WiFi base station, or may also be a mobile communication base station, such as a General Packet Radio Service (GPRS) base station, a 3G base station, a 4G base station, or a 5G base station.

Step 102: the network RTK server allocates a corresponding RTK base station correction number to the communication base station according to the position information, the RTK base station correction number being a differential correction number of an RTK physical base station within a first preset distance range from the communication base station or a differential correction number of an RTK virtual base station generated according to the position information.

In an exemplary embodiment, allocating, by the network RTK server, a corresponding RTK base station correction number to the communication base station according to the position information includes:

performing, by the network RTK server, following operations on each communication base station:

detecting whether the first preset distance range of the communication base station includes an RTK physical base station;

if the RTK physical base station is within the first preset distance range of the communication base station, allocating a differential correction number of the RTK physical base station to the communication base station; and

if the RTK physical base station is not within the first preset distance range of the communication base station, generating a differential correction number of the RTK virtual base station according to the position information and allocating to the communication base station.

In this embodiment, if there is an RTK physical base station near the communication base station, the network RTK server does not need to calculate the differential correction number of the RTK virtual base station for the communication base station, but can directly use the data of the RTK physical base station as the differential correction number. The data of the RTK physical base station are valid for all communication base stations whose radius is within the first preset distance range. For example, assuming that the first preset distance is 2 km, that is to say, all communication base stations within 2 km of the RTK physical base station can use the data of the RTK physical base station as the differential correction number. The network RTK server does not need to calculate the differential correction number of the RTK virtual base station for these communication base stations, which further reduces the amount of calculation of the network RTK server.

If there is no RTK physical base station near the communication base station, the embodiment of the present invention takes characteristics that all network RTK users need to request the network RTK correction number through a communication base station and network RTK server, and only calculates the differential correction number of the RTK virtual base station based on the position of the communication base station. The differential correction number of the RTK virtual base station based on the communication base station position is adapted to all users connected to the communication base station. Hence, the network RTK server does not need to know the actual position of each network RTK user, and does not need to establish a bi-directional communication with the network RTK user. The amount of calculation of the network RTK server is also only related to the communication base station number and is not related to the actual network RTK user number; in this way, it further reduces the calculation pressure of the network RTK server.

In an exemplary embodiment, for an algorithm for generating a differential correction number of the RTK virtual base station, an algorithm disclosed by Lambert W. may be adopted.

In an exemplary embodiment, generating a differential correction number of the RTK virtual base station according to the position information of the communication base station includes:

searching a station region to which the communication base station belongs according to the position information of the communication base station; and

calculating a differential correction number of the RTK virtual base station at a preset position in the station region to which the communication base station belongs.

In this embodiment, the shape of the station region may be a grid shape; the preset position may be at the center of the grid; the size of the grid is set according to an active degree of an ionized layer of the position where the grid is located.

For an urban area with dense communication base stations, distances among the communication base stations are generally only several meters. To further reduce the amount of calculation of the network RTK server, the region with dense communication base stations may be divided into a plurality of regions by means of grids; a side length of each grid may be two km, five km, or ten km. The differential correction number of the RTK virtual base station is calculated using grid center coordinates as a reference. The calculated differential correction number of the RTK virtual base station is applicable to all communication base stations in this grid. The size of the grid can be planned according to the activity degree of the ionosphere. In the middle latitude region where the ionosphere is relatively quiet, the grid is relatively sparse, with a side length of 5 km or even 10 km. For low and high latitude regions where the ionosphere is more active, the grid side length is smaller and 2 km is suitable.

In an exemplary embodiment, the method further includes:

the network RTK server establishes and store correspondence between each communication base station and the RTK physical base station or RTK virtual base station.

Specifically, the generation frequency of the network RTK correction number is generally one set per second. The network RTK server deliveries a set of network RTK correction numbers per second for each communication base station; the set of network RTK correction numbers may be a differential correction number for an RTK physical base station or a differential correction number for an RTK virtual base station. Either the differential correction number of the RTK virtual base station or the differential correction number of the RTK physical base station may be applicable to multiple communication base stations. Therefore, the differential correction numbers received per second by each communication base station may not be unique. The network RTK server can plan the correspondence between the RTK virtual base station or RTK physical base station and the communication base station according to each communication base station position and RTK physical base station position.

Step 103: the network RTK server sends the allocated RTK base station correction number to the communication base station.

The existing network RTK users usually need to interact with the network RTK server through the communication base station. The embodiment of the present invention makes full use of the wireless communication characteristics that the position of the communication base station is known and the users connected to the communication base station are all near the base station. The RTK base station correction number available to all network RTK users connected to the communication base station according to the position information of the communication base station is generated and broadcast by the communication base station to the network RTK user connected to the communication base station and requesting for the RTK base station correction number. The network RTK server does not need to know the position of each network RTK user. There is also no need to generate the differential correction number of the RTK virtual base station for each network RTK user, so that the service mode of the network RTK is converted from a bi-directional communication mode to a broadcast mode, which not only solves the bi-directional communication problem, but also solves the network RTK server, and relives the calculation pressure of the network RTK server.

An embodiment of the present invention further provides a storage medium storing one or more programs, where the one or more programs can be executed by one or more processors, to implement steps of the network RTK service method according to any one above.

An embodiment of the present invention further provides a network RTK server, including a processor and a memory, where the processor is configured to execute network RTK service programs stored in the memory, to implement steps of the network RTK service method according to any one above.

As shown in FIG. 2, an embodiment of the present invention further provides a network RTK service method, which includes the following steps:

Step 201: a communication base station receives an RTK base station correction number sent by a network RTK server, the RTK base station correction number being a differential correction number of an RTK physical base station within a first preset distance range from the communication base station or a differential correction number of an RTK virtual base station generated according to the position information; and

Step 202: the communication base station sends the received RTK base station correction number to one or more network RTK users connected to the communication base station.

In an exemplary embodiment, step 202 includes:

storing, by the communication base station, registration information of the one or more network RTK users connected to the communication base station;

sending, by the communication base station through broadcasting, the received RTK base station correction number to the one or more network RTK users connected to the communication base station.

Each communication base station receives a set of RTK base station correction numbers from the network RTK server every second, and the base station correction number may be a differential correction number of an RTK physical base station and may also be a differential correction number of an RTK virtual base station. For the communication users connected to the communication base station, some users will have network RTK correction number requests, for example, network RTK users; some users may not need the network RTK correction number RTK, for example, non-network RTK users. The network RTK server can send the network RTK user registration information to each communication base station, and save to a local server of each communication base station. The communication base station can broadcast the RTK base station correction number to the authenticated network RTK user. If the communication service provider wishes to provide RTK base station correction number to all users for free as a value-added service, for example, cellphone high precision RTK positioning service, it can broadcast the RTK base station correction number to all users connected to the communication base station without verifying user registration information. Smart cellphones all have a GNSS positioning function. In the absence of the RTK base station correction number, the positioning precision can only reach the precision of ten meters. If communication service providers can provide the RTK base station correction number, the positioning precision of the smart cellphones will be improved to a sub-meter level, which will greatly improve the positioning experience of the smart cellphones. If a certain communication service provider can provide an RTK base station correction number value-added service, it is bound to attract more communication users.

The network RTK service method of the embodiment of the present invention is very suitable for the communication service providers to establish CORS networks by themselves and provide value-added network RTK services for their own communication users, because in this way, there is no need to cooperate with the network RTK service providers. Moreover, if the network RTK service provider does not cooperate with the communication service provider, the position of each network RTK user cannot be obtained without bi-directional communication. Therefore, if the network RTK service provider does not cooperate with the communication service provider, it cannot bypass the requirement of bi-directional communication. The network RTK service method of the embodiment of the present invention can be used for eliminating the requirement of bi-directional communication and reducing the amount of calculation of the network RTK server by cooperating between the network RTK service provider and the communication service provider or establishing the CORS network by the communication service provider self to provide the network RTK service to the user.

An embodiment of the present invention further provides a storage medium storing one or more programs, where the one or more programs can be executed by one or more processors, to implement steps of the network RTK service method according to any one above.

An embodiment of the present invention further provides a communication base station, including a processor and a memory, where the processor is configured to execute network RTK service programs stored in the memory, to implement steps of the network RTK service method according to any one above.

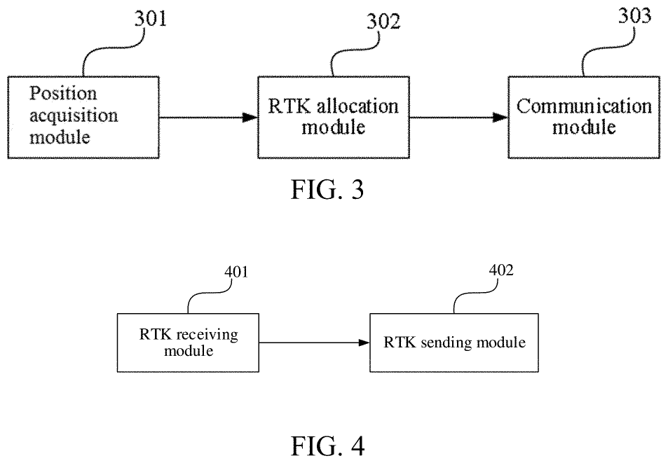

As shown in FIG. 3, an embodiment of the present invention further provides a network RTK server, including a position acquisition module 301, an RTK allocation module 302, and a communication module 303, where:

the position acquisition module 301 is configured to acquire position information of one or more communication base stations and notify the RTK allocation module 302;

the RTK allocation module 302 is configured to receive a notification from the position acquisition module 301, allocate a corresponding RTK base station correction number to the communication base station according to the position information, the RTK base station correction number being a differential correction number of an RTK physical base station within a first preset distance range from the communication base station or a differential correction number of an RTK virtual base station generated according to the position information, and notify the communication module 303; and

the communication module 303 is configured to receive a notification from the RTK allocation module 302 and send the allocated RTK base station correction number to the communication base station.

In an exemplary embodiment, the position acquisition module 301 pre-stores position information of one or more communication base stations or receives at fixed periods the position information of one or more communication base stations.

In an exemplary embodiment, the communication base station may be a short range wireless communication base station, for example, a WiFi base station, or may also be a mobile communication base station, such as a GPRS base station, a 3G base station, a 4G base station, or a 5G base station.

In an exemplary embodiment, the RTK allocation module 302 is specifically configured to:

perform following operations on each communication base station:

detecting whether the first preset distance range of the communication base station includes an RTK physical base station;

if the RTK physical base station is within the first preset distance range of the communication base station, allocating a differential correction number of the RTK physical base station to the communication base station; and

if the RTK physical base station is not within the first preset distance range of the communication base station, generating a differential correction number of the RTK virtual base station according to the position information and allocating to the communication base station.

In an exemplary embodiment, for an algorithm for generating a differential correction number of the RTK virtual base station by the RTK allocation module 302, an algorithm disclosed by Lambert W. may be adopted.

In an exemplary embodiment, generating a differential correction number of the RTK virtual base station by the RTK allocation module 302 according to the position information of the communication base station includes:

searching a station region to which the communication base station belongs according to the position information of the communication base station; and

calculating a differential correction number of the RTK virtual base station at a preset position in the station region to which the communication base station belongs.

In this embodiment, the shape of the station region may be a grid shape; the preset position may be at the center of the grid; the size of the grid is set according to an active degree of an ionized layer of the position where the grid is located.

In an exemplary embodiment, the RTK allocation module 302 is further configured to establish and store correspondence between each communication base station and the RTK physical base station or RTK virtual base station.

As shown in FIG. 4, an embodiment of the present invention further provides a communication base station including an RTK receiving module 401 and an RTK sending module 402, where:

the RTK receiving module 401 is configured to receive an RTK base station correction number sent by a network RTK server, the RTK base station correction number being a differential correction number of an RTK physical base station within a first preset distance range from the communication base station or a differential correction number of an RTK virtual base station generated according to the position information and notify the RTK sending module 402; and

the RTK sending module 402 is configured to receive a notification from the RTK receiving module 401 and send the received RTK base station correction number to one or more network RTK users connected to the communication base station.

In an exemplary embodiment, the RTK sending module 402 is specifically configured to:

acquire registration information of the one or more network RTK users connected to the communication base station; and

send, through broadcasting, the received RTK base station correction number to the one or more network RTK users connected to the communication base station.

Network RTK is the most important positioning mode in intelligent driving, intelligent robot, UAV, fine agriculture and other applications in the future intelligent era. In the three current network RTK solutions, FKP and Mac do not require bi-directional communication, but are only suitable for local area scope. VRS is suitable for wide area range, but it requires bi-directional communication, and calculating the differential correction number of the RTK virtual base station independently for each user greatly increases the burden of the server, which cannot meet the needs of tens of millions of users in the intelligent era. In the 4G era, VRS users all interact with the network RTK server through a 4G network to provide their positions, and the server calculates the differential correction number of the RTK virtual base station applicable to the user's position and sends it to the user. In the future 5G era, users will also receive the network RTK correction number through the 5G network. In 4G and future 5G communication links, users may exchange data with each other through the nearest communication base station (or the base station with the strongest signal). The coverage range of each communication base station is also relatively limited, generally only about 1 km in urban areas, and no more than 5 km in remote areas with less population, so the users of the communication base station service are all located near the base station. The embodiment of the present invention makes use of the feature of wireless communication to determine the user's position through the communication base station connected by the user, so when the user requests the network RTK correction number, there is no need to upload his position. For the network RTK server, instead of calculating the differential correction number of the RTK virtual base station for each customer, only the differential correction number of the RTK virtual base station based on the position of each communication base station is needed. The correction number for each communication base station is applicable to all users connected to this base station, because most of the users connected to this base station are within the range of 1 km, while the network RTK correction number based on the specified position is valid for users within the range of 20 km.

The embodiment of the present invention does not need a bi-directional communication between the user and the network RTK server, which also relieves the calculation pressure of the network RTK server; there is no need for calculating the differential correction number of the RTK virtual base station for each user, but only needing calculating for each communication base station the differential correction number of the RTK virtual base station, to be broadcast by the communication base station to all users connected to the base station. To change the current bi-directional communication to a broadcast mode, the server does not need to know the position of each user, and the amount of calculation of the server is independent of the number of users requiring the network RTK correction number. In the urban area with dense communication base stations, the server even does not need to calculate the differential correction number of the RTK virtual base station for each communication base station, but only needs to calculate the differential correction number of set of RTK virtual base stations for a plurality of virtual base stations in a certain range. This set of correction numbers may provide the network RTK correction number for all users connected to the plurality of communication base stations in a specified range. A communication base station can serve tens of thousands of wireless users, and the number of communication base stations is far smaller than the number of users connected to all the base stations. In particular, in the future intelligent era, a large number of customers requiring high-precision positioning will break out. This service mode, which is unrelated with the number of users, solves the difficult problem that the number of users can only be increased by enhancing the calculation capacity of the network RTK server.

A person having ordinary skill in the art can understand that all or some of the steps of the method, systems, and functional modules/units in the device disclosed above can be implemented as software, firmware, hardware, and their appropriate combinations. In hardware implementations, the division between functional modules/units mentioned in the above description does not necessarily correspond to the division of physical assemblies; for example, a physical assembly can have a plurality of functions, or a function or step can be performed by several physical assemblies in cooperation. Some or all assemblies may be implemented as software executed by processors, such as digital signal processors or microprocessors, or as hardware, or as integrated circuits, for example, an application-specific integrated circuit. Such software may be distributed on the computer readable medium; the computer readable medium may include computer storage media (or non-transient media) and communication media (or transient media). As well-known for a person having ordinary skill in the art, the term the computer storage medium includes volatile and non-volatile, removable and non-removable media that store information such as computer-readable instructions, data structures, program modules, or other data and that are implemented by using any method or technology. The computer storage medium includes, but not limited to, RAM, ROM, EEPROM, flash or other storage technology, CD-ROM, Digital Versatile Disc (DVD) or other optical disk storage, magnetic cartridge, magnetic tape, disk storage or other magnetic storage devices, or any other media that can be used for storing desired information and can be accessed by a computer. In addition, it is well known to a person having ordinary skill in the art that a communication medium usually includes computer-readable instructions, data structures, program modules, or other data in a modulated data signal such as a carrier or other transmission mechanisms, and may include any information delivery medium.

1. A network RTK service method, comprising:
acquiring, by a network RTK server, position information of one or more communication base stations;
allocating, by the network RTK server, a corresponding RTK base station correction number to the communication base station according to the position information, wherein the RTK base station correction number is a differential correction number of an RTK physical base station within a first preset distance range from the communication base station, or a differential correction number of an RTK virtual base station generated according to the position information; and
sending, by the network RTK server, the allocated RTK base station correction number to the communication base station.

2. The method according to claim 1, wherein allocating, by the network RTK server, the corresponding RTK base station correction number to the communication base station according to the position information comprising:
performing, by the network RTK server, following operations on each communication base station:
detecting whether the RTK physical base station is within the first preset distance range of the communication base station;
if the RTK physical base station is within the first preset distance range of the communication base station, allocating the differential correction number of the RTK physical base station to the communication base station; and
if the RTK physical base station is not within the first preset distance range of the communication base station, generating the differential correction number of the RTK virtual base station according to the position information and allocating the differential correction number to the communication base station.

3. The method according to claim 2, wherein generating the differential correction number of the RTK virtual base station according to the position information comprises:
searching a network region to which the communication base station belongs according to the position information; and
calculating the differential correction number of the RTK virtual base station at a preset position in the network region.

4. A storage medium storing one or more programs, wherein the one or more programs can be executed by one or more processors to implement steps of the network RTK service method according to claim 1.

5. A network RTK server, comprising a processor and a memory, wherein the processor is configured to execute a network RTK service program stored in the memory, to implement steps of the network RTK service method according to claim 1.

6. A network RTK service method, comprising:
receiving, by a communication base station, an RTK base station correction number sent by a network RTK server, wherein the RTK base station correction number is a differential correction number of an RTK physical base station within a first preset distance range from the communication base station, or a differential correction number of an RTK virtual base station generated according to the position information; and
sending, by the communication base station, the received RTK base station correction number to one or more network RTK users connected to the communication base station.

7. The method according to claim 6, wherein sending, by the communication base station, the received RTK base station correction number to one or more network RTK users connected to the communication base station comprises:
storing, by the communication base station, registration information of the one or more network RTK users connected to the communication base station; and
sending, by the communication base station through broadcasting, the received RTK base station correction number to the one or more network RTK users connected to the communication base station.

8. A storage medium storing one or more programs, wherein the one or more programs can be executed by one or more processors to implement steps of the network RTK service method according to claim 6.

9. A communication base station comprising a processor and a memory, wherein the processor is configured to execute a network RTK service program stored in the memory, to implement steps of the network RTK service method according to claim 6.

10. A network RTK server comprising a position acquisition module, an RTK allocation module, and a communication module, wherein:
the position acquisition module is configured to acquire position information of one or more communication base stations and notify the RTK allocation module;
the RTK allocation module is configured to receive a notification from the position acquisition module, allocate a corresponding RTK base station correction number to the communication base station according to the position information, wherein the RTK base station correction number is a differential correction number of an RTK physical base station within a first preset distance range from the communication base station, or a differential correction number of an RTK virtual base station generated according to the position information, and notify the communication module; and
the communication module is configured to receive a notification from the RTK allocation module and send the allocated RTK base station correction number to the communication base station.

11. A communication base station comprising an RTK receiving module and an RTK sending module, wherein:
the RTK receiving module is configured to receive an RTK base station correction number sent by a network RTK server, wherein the RTK base station correction number is a differential correction number of an RTK physical base station within a first preset distance range from the communication base station or a differential correction number of an RTK virtual base station generated according to the position information, and notify the RTK sending module; and
the RTK sending module is configured to receive a notification from the RTK receiving module and send the received RTK base station correction number to one or more network RTK users connected to the communication base station.
